(19) United States
(12) Patent Application Publication
(10) Pub. No.: US 2019/0082030 A1
(43) Pub. Date: Mar. 14, 2019

(54) REDUCING ELECTRONIC RESOURCE CONSUMPTION USING QUALITY MODEL

(71) Applicant: LinkedIn Corporation, Sunnyvale, CA (US)

(72) Inventors: Jessie Tang, San Jose, CA (US); Jason Phan, San Francisco, CA (US); Mads Johnsen, San Jose, CA (US)

(21) Appl. No.: 15/699,845

(22) Filed: Sep. 8, 2017

(51) Int. Cl. H04L 29/08; G06Q 10/10; G06Q 50/00

(52) U.S. Cl. CPC H04L 67/322; H04L 67/02; G06Q 50/01; H04L 67/22; G06Q 10/1053; H04L 67/306

(57) ABSTRACT

Techniques for reducing electronic resource consumption using a quality model are disclosed herein. In some embodiments, a data quality system receives a request from a first device of a first user of a social network service, identifies digital content based on the request, and accesses user data of the first user, with the user data of the first user comprising at least one of profile data of the first user and activity data of the first user. In some embodiments, the data quality system determines that the accessed user data of the first user does not satisfy a quality model, with the quality model requiring that at least two criteria of a plurality of criteria be satisfied by the accessed user data, and performs a restriction operation based on the determining that the accessed user data of the first user does not satisfy the quality model.

### TECHNICAL FIELD

The present application relates generally to information retrieval and, in one specific example, to methods and systems of reducing electronic resource consumption using a quality model.

### BACKGROUND

Online services, such as social networking services, often suffer from excessive consumption of electronic resources (e.g., consuming network bandwidth, consuming real estate on a display screen of a device) in the performance of certain operations due to those operations being performed for low quality data or entities.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a data quality system, in accordance with an example embodiment.

FIG. 4 illustrates a graphical user interface (GUI) displaying digital content, in accordance with an example embodiment.

FIG. 5 illustrates a GUI displaying a selectable option for submitting input associated with digital content, in accordance with an example embodiment.

FIG. 6 is a flowchart illustrating a method of reducing electronic resource consumption using a quality model, in accordance with an example embodiment.

FIG. 7 illustrates a mapping of users to determinations of whether the users satisfy criteria, in accordance with an example embodiment.

FIG. 8 is a block diagram illustrating a mobile device, in accordance with some example embodiments.

FIG. 9 is a block diagram of an example computer system on which methodologies described herein may be executed, in accordance with an example embodiment.

### DETAILED DESCRIPTION

Example methods and systems of reducing electronic resource consumption using a quality model are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure provides example embodiments in which a system leverages data points as a proxy for quality in order to reduce the consumption of electronic resources associated with the performance of operations for low quality data and entities. In some example embodiments, operations are performed by a machine having a memory and at least one hardware processor, with the operations comprising: receiving a request from a first device of a first user of a social network service; identifying digital content based on the request; accessing user data of a first user of a social networking service, the user data of the first user comprising at least one of profile data of the first user and activity data of the first user; determining that the accessed user data of the first user does not satisfy a quality model, the quality model requiring that at least two criteria of a plurality of criteria be satisfied by the accessed user data; and performing a restriction operation based on the determining that the accessed user data of the first user does not satisfy the quality model, the restriction operation comprising one of preventing the digital content from being displayed to the first user, preventing the first user from submitting input associated with the digital content to the social networking service, and preventing input submitted by the first user in association with the digital content submitted from being displayed on a second device of a second user.

In some example embodiments, the digital content comprises a job posting. In some example embodiments, the user data comprises the profile data, the profile data comprising a geographic location of the first user, and the plurality of criteria comprises the geographic location of the first user being within a predetermined geographical location. In some example embodiments, the user data comprises the activity data, the activity data comprising a number of times the first user has applied for a job within a predetermined period of time, and the plurality of criteria comprises the number of times the first user has applied for a job within the predetermined period of time being less than a threshold number. In some example embodiments, the user data comprises the profile data, the profile data comprising a salary data of the first user, and the plurality of criteria comprises the salary data of the first user being within a predetermined range.

In some example embodiments, the restriction operation comprises preventing the job posting from being displayed to the first user. In some example embodiments, the restriction operation comprises preventing the first user from submitting input in association with the job posting to the social networking service, the job posting having been displayed to on the first device of the first user via the social networking service. In some example embodiments, the restriction operation comprises preventing input submitted by the first user in association with the job posting via the social networking service from being displayed on a second device of a second user.

In some example embodiments, the operations further comprise: accessing performance data of the social networking service; and using a machine learning algorithm to modify the quality model based on the accessed performance data.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

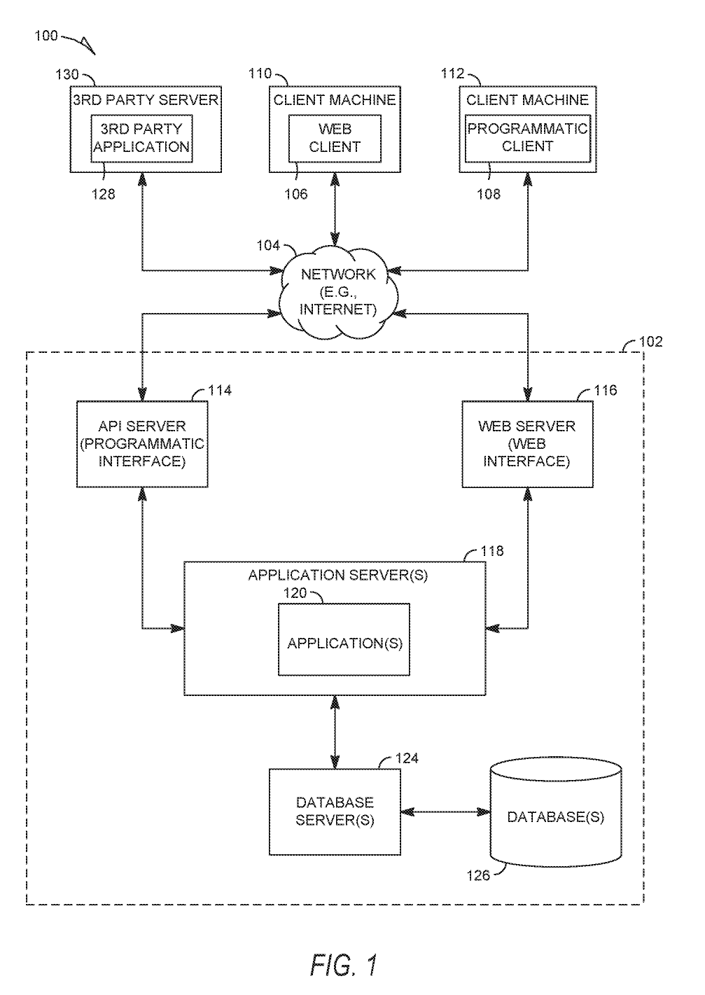

FIG, 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

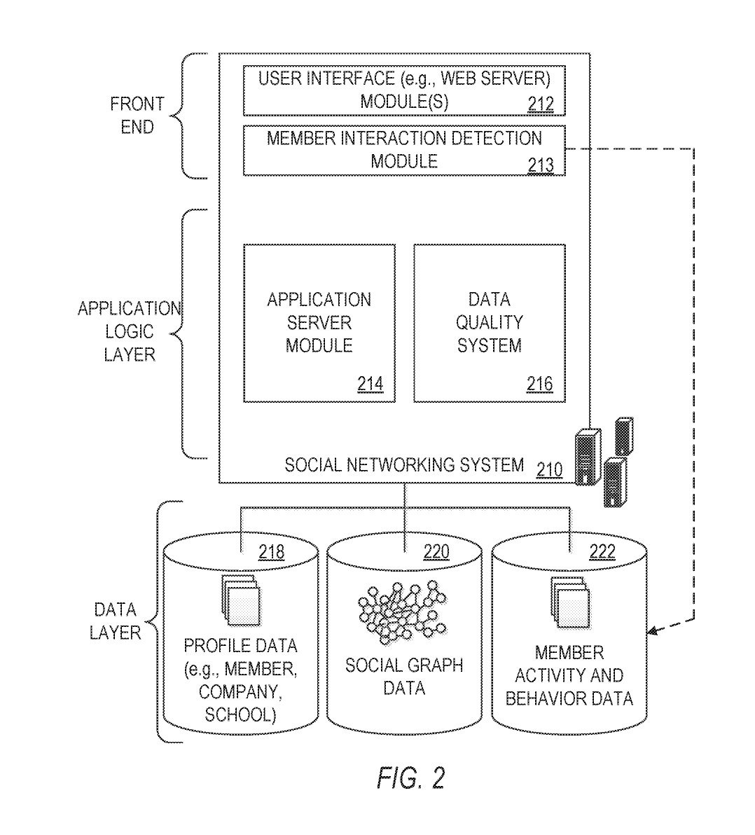

In some embodiments, the networked system 102 may comprise functional components of a social networking service. FIG. 2 is a block diagram showing the functional components of a social networking system 210, including a data processing module referred to herein as an data quality system 216, for use in social networking system 210, consistent with some embodiments of the present disclosure. In some embodiments, the data quality system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the data quality system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2. by the database 222. This logged activity information may then be used by the data quality system 216.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the data quality system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

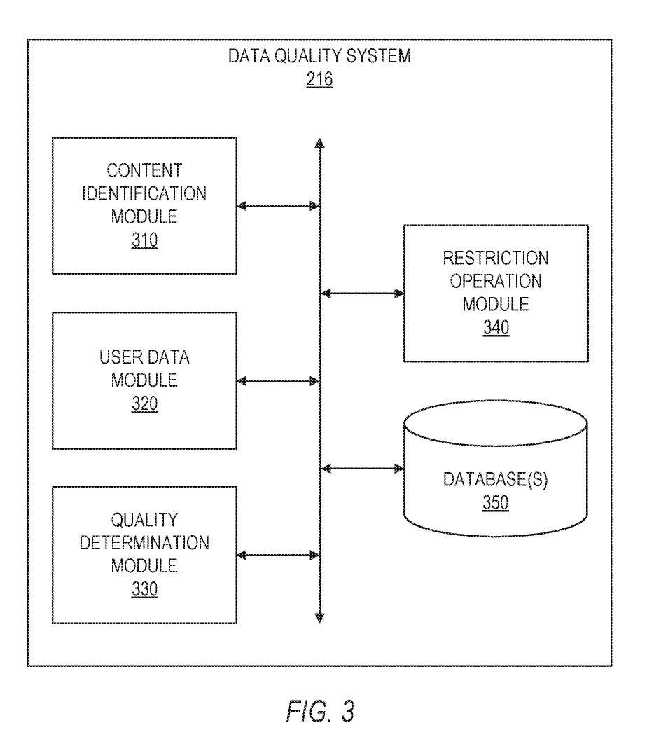

FIG. 3 is a block diagram illustrating components of the data quality system 216, in accordance with an example embodiment. In some embodiments, the data quality system 216 comprises any combination of one or more of a content identification module 310, a user data module 320, a quality determination module 330, a restriction operation module 340, and one or more databases 350. The content identification module 310, the user data module 320, the quality determination module 330, the restriction operation module 340, and the database(s) 350 can reside on a machine having a memory and at least one processor (not shown). In some embodiments, the content identification module 310, the user data module 320, the quality determination module 330, the restriction operation module 340, and the database(s) 350 can be incorporated into the application server(s) 118 in FIG. 1. In some example embodiments, the database(s) 350 is incorporated into database(s) 126 in FIG. 1 and can include any combination of one or more of databases 218, 220, and 222 in FIG. 2. However, it is contemplated that other configurations of the modules 310, 320, 330, and 340, as well as the database(s) 350, are also within the scope of the present disclosure.

In some example embodiments, one or more of the content identification module 310, the user data module 320, the quality determination module 330, and the restriction operation module 340 is configured to provide a variety of user interface functionality, such as generating user interfaces, interactively presenting user interfaces to the user, receiving information from the user (e.g., interactions with user interfaces), and so on. Presenting information to the user can include causing presentation of information to the user e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the content identification module 310, the user data module 320, the quality determination module 330, and the restriction operation module 340 is configured to receive user input. For example, one or more of the modules 310, 320, 330, and 340 can present one or more GUI elements (e.g., drop-down menu, selectable buttons, text field) with which a user can submit input.

In some example embodiments, one or more of the modules 310, 320, 330 and 340 is configured to perform various communication functions to facilitate the functionality described herein, such as by communicating with the social networking system 210 via the network 104 using a wired or wireless connection. Any combination of one or more of the modules 310, 320, 330, and 340 may also provide various web services or functions, such as retrieving information from the third party servers 130 and the social networking system 210. Information retrieved by the any of the modules 310, 320. 330, and 340 may include profile data corresponding to users and members of the social networking service of the social networking system 210.

Additionally, any combination of one or more of the modules 310, 320, 330, and 340 can provide various data functionality, such as exchanging information with database(s) 350 or servers. For example, any of the modules 310, 320, 330, and 340 can access member profiles that include profile data from the database(s) 350, as well as extract attributes and/or characteristics from the profile data of member profiles (e.g., profile data from database 218). Furthermore, the one or more of the modules 310, 320, 330, and 340 can access social graph data (e.g., social graph data from database 220) and member activity and behavior data (e.g., member activity and behavior data from database 222) from database(s) 350, as well as exchange information with third party servers 130, client machines 110, 112, and other sources of information.

In some example embodiments, the content identification module 310 is configured to receive a request from a first device of a first user of a social network service. In some example, embodiments, the request comprises a search query comprising text that is used as part of a search for search results, such as by searching documents that contain or are related to the text. The request may be submitted by the first user in a variety of ways. For example, the first user can enter text into a search field and select a “Search” button (or the like), or the first user can select a link that represents text (e.g., selecting a link that reads “software engineer” to submit a search query for “software engineer”). It is contemplated that the request may be submitted by the first user in other ways as well, and that other types of requests are within the scope of the present disclosure.

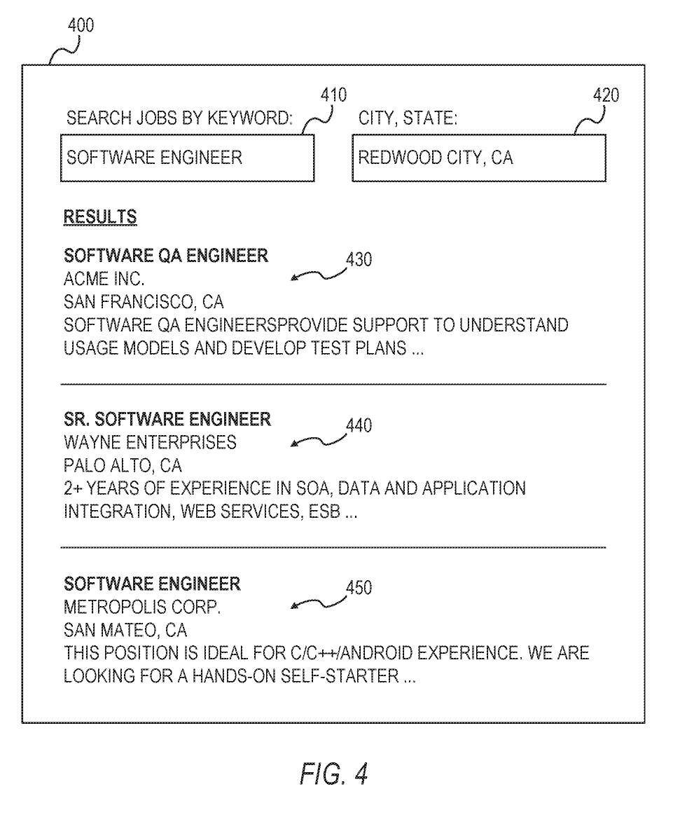

In some example embodiments, the content identification module 310 is further configured to identify digital content based on the request. in some example embodiments, the digital content comprises one or more job postings. FIG. 4 illustrates a GUI 400 displaying digital content, in accordance with an example embodiment. In the example shown in FIG. 4, the GUI. 400 includes two search fields 410 and 420 comprising text entered by a user as part of a search request for job postings. Search field 410 comprises the text “SOFTWARE ENGINEER” and search field 420 comprises the text “REDWOOD CITY, Calif.” As a result of the user entering this text into fields 410 and 420 and requesting a search on the entered text (e.g., by selecting a “Search” button or the like), the content identification module 310 receives the request, and performs a search for job listings that are relevant to the search query, such as job listings that are for software engineer positions (or related positions) and that are located in or near Redwood City, Calif. In FIG. 4, the content identification module 310 has identified digital content 430, digital content 440, and digital content 450 based on the request. Digital content 430 comprises a job posting for a “SOFTWARE QA ENGINEER” position, digital content 440 comprises a job posting for a “SR. SOFTWARE ENGINEER” position, and digital content 450 comprises a job posting for a “SOFTWARE ENGINEER” position. Each job posting may comprise information about the corresponding position, including, but not limited to, company hiring for the position, geographic location of the position, and description or requirements of the position.

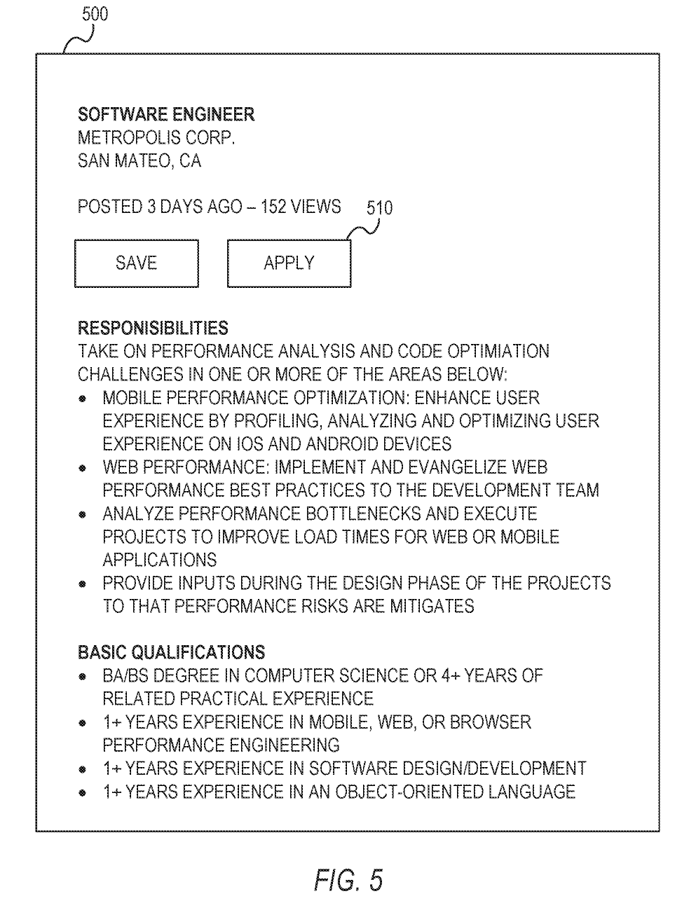

In some example embodiments, the job postings listed as the results of the search are selectable, enabling the user to find out more information about the position of the selected job posting and be presented with a selectable option for submitting input associated with the job posting. FIG. 5 illustrates a GUI 500 displaying a selectable option 510 for submitting input associated with digital content, in accordance with an example embodiment. In FIG. 5, the user has selected the job posting of digital content 450 in FIG. 4, resulting in the GUI 500 in FIG. 5 displaying more information about the selected job posting and presenting the user with the selectable option 510 for submitting input associated with the job posting by applying for the job posting. In some example embodiments, the data quality system 216 is configured to enable a user to submit input associated with the job posting, such as by uploading a resume or filling in a job application form. Such input may be received by the data quality system and then displayed, or otherwise presented, to another user, such as a member of the company for which the job posting was posted.

However, the first user for whom the digital content was identified might not be a suitable user to whom to display the digital content or from who to receive and process input associated with the digital content. For example, the first user might be a low quality applicant for a particular job posting that was identified based on a search query submitted by the first user, meaning that enabling the first user to participate in that particular job posting is unlikely to result in a beneficial outcome for the company hiring for the position corresponding to the job posting, as the first user is likely not qualified for the position. Performing operations that allow such a low quality applicant to participate in that particular job posting wastes electronic resources, such as by consuming network bandwidth in transmitting the job posting to the device of the user, consuming network bandwidth in transmitting the input associated with the job posting (e.g., a resume or job application data) from the device of the user, consuming real estate on the display screen of the device of the user when displaying the job posting on the device of the user, and consuming real estate on the display screen of the device of a member or agent of the company that is reviewing the input (e.g., resume or job application data) submitted by the user in association with the job posting.

Referring back to FIG. 3, in some example embodiments, the user data module 320 is configured to access user data of the first user. In some example embodiments, the user data of the first user comprises at least one of profile data of the first user and activity data of the first user. The user data module 320 may access and retrieve the profile data from database 218. In some example embodiments, the profile data comprises a geographic location of the first user, such as the country of residence of the first user. In some example embodiments, the profile data comprises salary data of the first user, such as an estimated current salary of the first user. The user data module 320 may predict the current salary of the first user based on other profile data of the first user. For example, in some example embodiments, the user data module 320 uses information from the profile of the first user, such as current job position (e.g. current job title), current job location (e.g., current country of employment), and seniority (e.g., years of experience), to estimate the current salary of the first user. In some example embodiments, the user data module 320 accesses and retrieves activity data, such as activity data stored in database 222. The activity data may comprise an indication of the number of times the first user has applied for a job within a predetermined period of time (e.g., the first user has applied for 19 jobs within the last 2 weeks). It is contemplated that other types of profile data and activity data may also be accessed for use in the operations of the present disclosure.

In some example embodiments, the quality determination module 330 is configured to determine whether or not the accessed user data of the first user satisfies a quality model. The quality model requires that at least two criteria of a plurality of criteria be satisfied by the accessed user data. In some example embodiments, the plurality of criteria comprises the geographic location of the first user being within a predetermined geographical location, such as the country of residence of the first user being the same as the country of the position to which the job posting corresponds. For example, if the job posting is for a software engineer position in the United States, then one of the plurality of criteria may be that the first user currently resides in the United States. Such criteria ensures that a job applicant is located within a reasonable distance of the job of the job posting, and helps filter out internet bots that consume electronic resources.

In some example embodiments, the plurality of criteria comprises the number of times the first user has applied for a job within a predetermined period of time being less than a threshold number. For example, one of the plurality of criteria may be that the first user has not applied to more than 50 jobs within the last year. Such criteria ensures that a job applicant is not a bulk applier, and helps filter out internet hots that consume electronic resources.

In some example embodiments, the plurality of criteria comprises the salary data of the first user being within a predetermined range. For example, one of the plurality of criteria may be that the estimated salary of the first user is within 40% of the salary being offered for the position of the job posting.

The inventors of the present application have found that embodiments where the quality model requires at least two criteria of a plurality of criteria be satisfied by the accessed user data, and where the plurality of criteria comprises all three of the above-discussed criteria for geographic location, number of time applying for a job within a predetermined period of time, and salary data are used for the plurality of criteria have resulted in a significant improvement in identifying low quality applicants compared to other embodiments. However, it is contemplated that other criteria and combinations of criteria are also within the scope of the present disclosure.

In some example embodiments, the quality determination module 330 is configured to identify the first user as low quality based on the determination that the accessed user data of the first user does not satisfy the quality module. The quality determination module 330 may store such low quality identification in database(s) 350 in association with the first user for subsequent use.

In some example embodiments, the restriction operation module 340 is configured to perform a restriction operation based on a determination that the accessed user data of the first user does not satisfy the quality model. In some example embodiments, the restriction operation comprises one of preventing digital content from being displayed to the first user, preventing the first user from submitting input associated with the digital content to the social networking service, and preventing input submitted by the first user in association with the digital content submitted from being displayed on a second device of a second user.

In some example embodiments, preventing digital content from being displayed to the first user comprises preventing a job posting from being displayed to the first user. For example, referring to FIG. 4, if the quality determination module 330 determined that accessed user data of the first user does not satisfy the quality model with respect to the job posting of digital content 440, the restriction operation module 340 may prevent the job posting of digital content 440 from being displayed, or otherwise presented, to the first user, such as by omitting the job posting of digital content 440 from the search results.

In some example embodiments, preventing the first user from submitting input associated with the digital content to the social networking service comprises preventing the first user from submitting input in association with the job posting to the social networking service, where the job posting has been displayed on the first device of the first user via the social networking service. For example, referring to FIG. 5, if the quality determination module 330 determined that accessed user data of the first user does not satisfy the quality model with respect to the job posting of digital content 440, the restriction operation module 340 may prevent the first user from applying for the job posting, such as by omitting the selectable “Apply” button 510 from the GUI 500 or otherwise not allowing the first user to submit input (e.g. a job resume or job application data) associated with the job posting.

In some example embodiments, preventing input submitted by the first user in association with the digital content submitted from being displayed on a second device of a second user comprises preventing input (e.g., an uploaded job resume or job application data) submitted by the first user in association with the job posting via the social networking service from being displayed on a second device of a second user. For example, the first user may submit an application or application data for the job posting to the social networking service, but the social networking service may block or omit that submitted application or application data from being displayed to another user responsible for reviewing applications or applications data for the job posting, such as by preventing the submitted application or application data from being transmitted to an e-mail inbox of the other user.

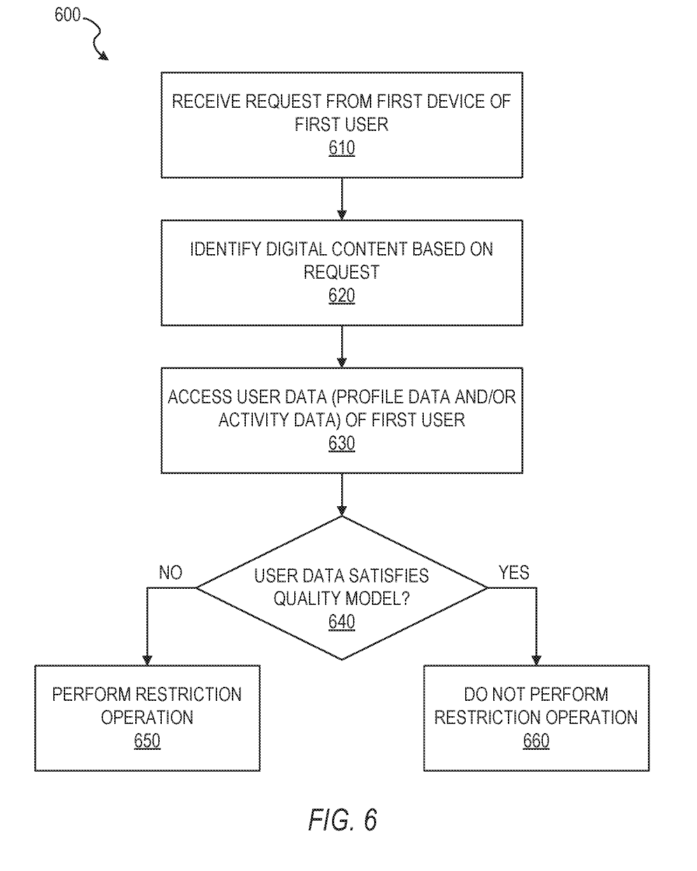

FIG. 6 is a flowchart illustrating a method 600 of reducing electronic resource consumption using a quality model, in accordance with an example embodiment. Method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the data quality system 216 of FIGS. 2-3, or any combination of one or more of its modules, as described above.

At operation 610, the data quality system 216 receives a request from a first device of a first user of a social network service. In some example embodiments, the request comprises a search query comprising text to be used in a search for digital content.

At operation 620, the data quality system 216 identifies digital content based on the request. In some example embodiments, the digital content comprises a job posting.

At operation 630, the data quality system 216 accesses user data of a first user of a social networking service. In some example embodiments, the user data of the first user comprises at least one of profile data of the first user and activity data of the first user. In some example embodiments, the user data of the first user comprises both profile data of the first user and activity data of the first user.

At operation 640, the data quality system 216 determines whether or not the accessed user data of the first user satisfies a quality model. In some example embodiments, the quality model requires that at least two criteria of a plurality of criteria be satisfied by the accessed user data. In some example embodiments, the profile data comprises a geographic location of the first user, and the plurality of criteria comprises the geographic location of the first user being within a predetermined geographical location. In some example embodiments, the profile data comprises a salary data of the first user, and the plurality of criteria comprises the salary data of the first user being within a predetermined range. In some example embodiments, the activity data comprises a number of times the first user has applied for a job within a predetermined period of time, and the plurality of criteria comprises the number of times the first user has applied for a job within the predetermined period of time being less than a threshold number.

If it is determined, at operation 640, that the accessed user data of the first user satisfies the quality model, then the method 600 proceeds to operation 650, where the data quality system 216 performs a restriction operation based on the determining that the accessed user data of the first user does not satisfy the quality model. In some example embodiments, the restriction operation comprises one of preventing the digital content from being displayed to the first user, preventing the first user from submitting input associated with the digital content to the social networking service, and preventing input submitted by the first user in association with the digital content submitted from being displayed on a second device of a second user.

In some example embodiments, the restriction operation comprises preventing a job posting from being displayed to the first user. In some example embodiments, the restriction operation comprises preventing the first user from submitting input in association with a job posting to the social networking service, where the job posting has been displayed to on the first device of the first user via the social networking service. In some example embodiments, the restriction operation comprises preventing input submitted by the first user in association with a job posting via the social networking service from being displayed on a second device of a second user.

If it is determined, at operation 640, that the accessed user data of the first user satisfies the quality model, then the method 600 proceeds to operation 660, where the data quality system 216 does not perform the restriction operation.

It is contemplated that any of the other features described within the present disclosure can be incorporated into method 600.

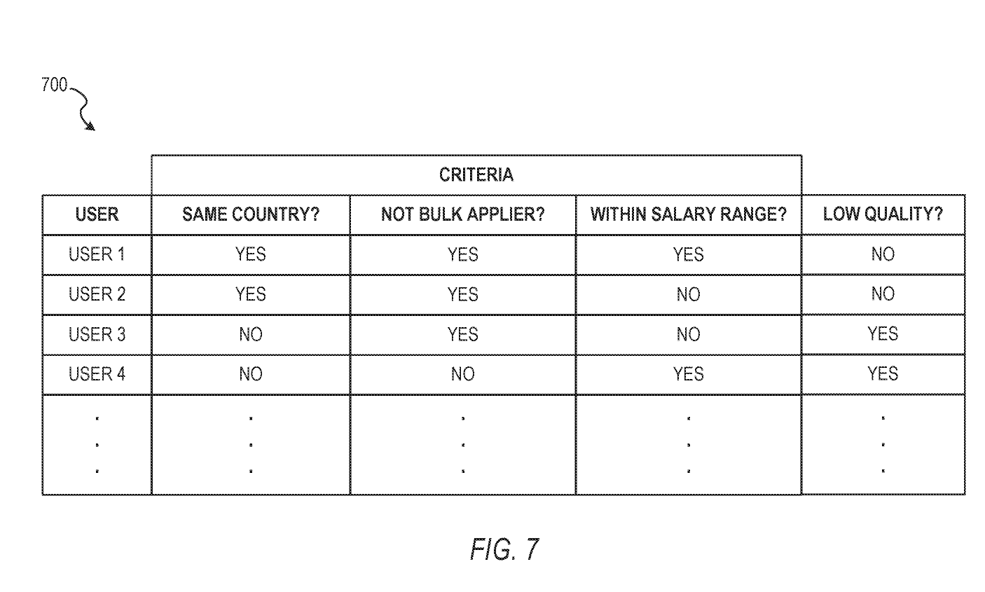

FIG. 7 illustrates a mapping 700 of users to determinations of whether the users satisfy criteria, in accordance with an example embodiment. For each user in the mapping (e.g., USER 1, USER 2, USER 3, USER 4, etc.), the data quality system 216 determines whether the user satisfies certain criteria of a plurality of criteria. In the example of FIG. 7, the plurality of criteria comprises the geographic location of the user being within the same country as a position of a job posting for which the user is being evaluated with respect to the criteria (e.g., if the job posting is in the United States, it is determined whether or not the user currently resides within the United States). In the example of FIG. 7, the plurality of criteria also comprises the user not being a bulk applier (e.g., it is determined whether the number of times the user has applied for a job within a predetermined period of time is less than a threshold number). In the example of FIG. 7, the plurality of criteria also comprises the salary data of the user being within a predetermined range (e.g., it is determined whether or not the estimated current salary of the user is within 40% of the $100,000 salary of the job posting for which the user is being evaluated with respect to the criteria).

As seen in the example in FIG. 7, the data quality system 216 determines whether or not each user is a low quality applicant based on a quality model and the determinations of each criteria. In the example of FIG. 7, the quality model requires that at least two criteria of a plurality of criteria be satisfied by the accessed user data of a user for which the determinations are being made, and the plurality of criteria consists of the three criteria discussed above (same country, not a bulk applier, and within a predetermined salary range). For each user, the data quality system 216 determines whether or not the user satisfies at least two of these three criteria. If the data quality system 216 determines that a user does not satisfy at least two of these three criteria, then the data quality system 216 identifies that user as a low quality applicant and performs a restriction operation, as previously discussed, based on this identification of the user as a low quality applicant. Otherwise, if the data quality system 216 determined that a user does satisfy at least two of the three criteria, then the data quality system 216 identifies that user as not being a low quality applicant and does not perform the restriction operation, thereby allowing the user to be treated using a non-restricted process, such as by not preventing a job posting from being displayed to the user, not preventing the user form submitting input in association with the job posting, and not preventing input submitted by the user in association with the job posting from being displayed to another user.

In the example of FIG. 7, the data quality system 216 has determined that USER 1 satisfies all three criteria, and therefore has determined USER 1 to not be a low quality applicant. The data quality system 216 has also determined that USER 2 satisfies two of the three criteria (same country and not a bulk applier), and therefore has determined USER 2 to not be a low quality applicant. The data quality system 216 has further determined that USER 3 satisfies only one of the three criteria (not a bulk applier), and therefore has determined USER 3 to be a low quality applicant. The data quality system 216 has also determined that USER 4 also satisfies only one of the three criteria (within a predetermined salary range), and therefore has determined USER 4 to be a low quality applicant.

The inventors of the present disclosure have found that using a quality model that requires at least two of three criteria discussed above (same country, not a bulk applier, and within a predetermined salary range) be satisfied has resulted in a significant improvement in identifying low quality applicants compared to other embodiments, it is contemplated that other criteria and combinations of criteria are also within the scope of the present disclosure. In some example embodiments, the data quality system 216 is configured to employ a machine learning process (e.g., regression analysis) on performance data of the social networking service to modify the quality model, such as by changing the combination of criteria used (e.g., replacing the same country criteria with an experience level criteria) and/or by changing the number or percentage of criteria that need to be satisfied in order to satisfy the quality model (e.g., replacing the requirement that at least two out of three criteria be satisfied with a requirement that all three criteria be satisfied). In some example embodiments, the data quality system 216 accesses performance data of the social networking service in order to perform such a machine learning process. The performance data may comprise data indicating different profile data and different activity data of users that applied for jobs of job postings, and which users were hired or accepted the jobs versus which users were not hired or did not accept the jobs. Based on such performance data, the data quality system 216 can fine tune the quality model.

### Example Mobile Device

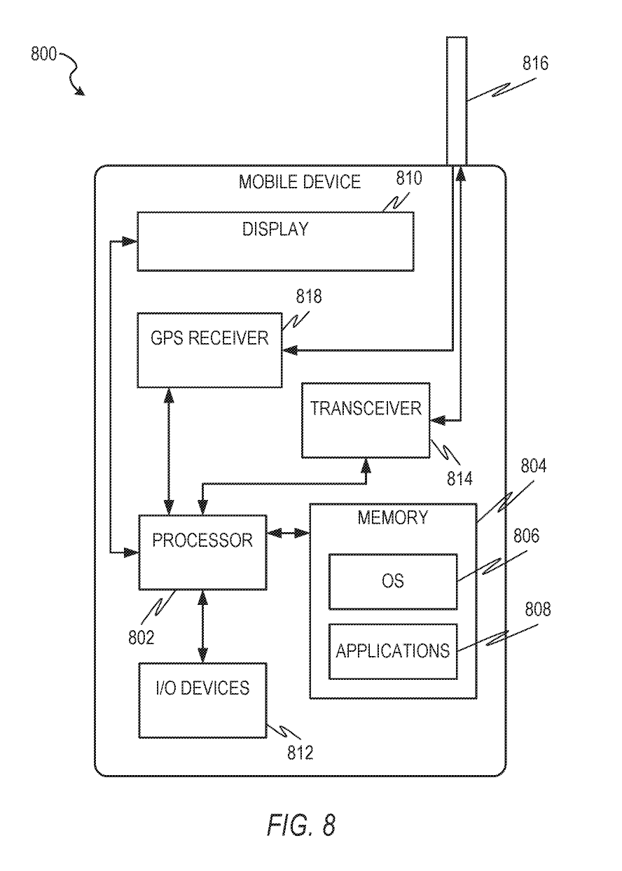

FIG. 8 is a block diagram illustrating a mobile device 800, according to an example embodiment. The mobile device 800 can include a processor 802. The processor 802 can be any of a variety of different types of commercially available processors suitable for mobile devices 800 (for example, an XScale architecture microprocessor, a Microprocessor without Interlocked Pipeline Stages (MIPS) architecture processor, or another type of processor). A memory 804, such as a random access memory (RAM), a Flash memory, or other type of memory, is typically accessible to the processor 802. The memory 804 can be adapted to store an operating system (OS) 806, as well as application programs 808, such as a mobile location-enabled application that can provide location-based services (LBSs) to a user. The processor 802 can be coupled, either directly or via appropriate intermediary hardware, to a display 810 and to one or more input/output (I/O) devices 812, such as a keypad, a touch panel sensor, a microphone, and the like. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a. service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

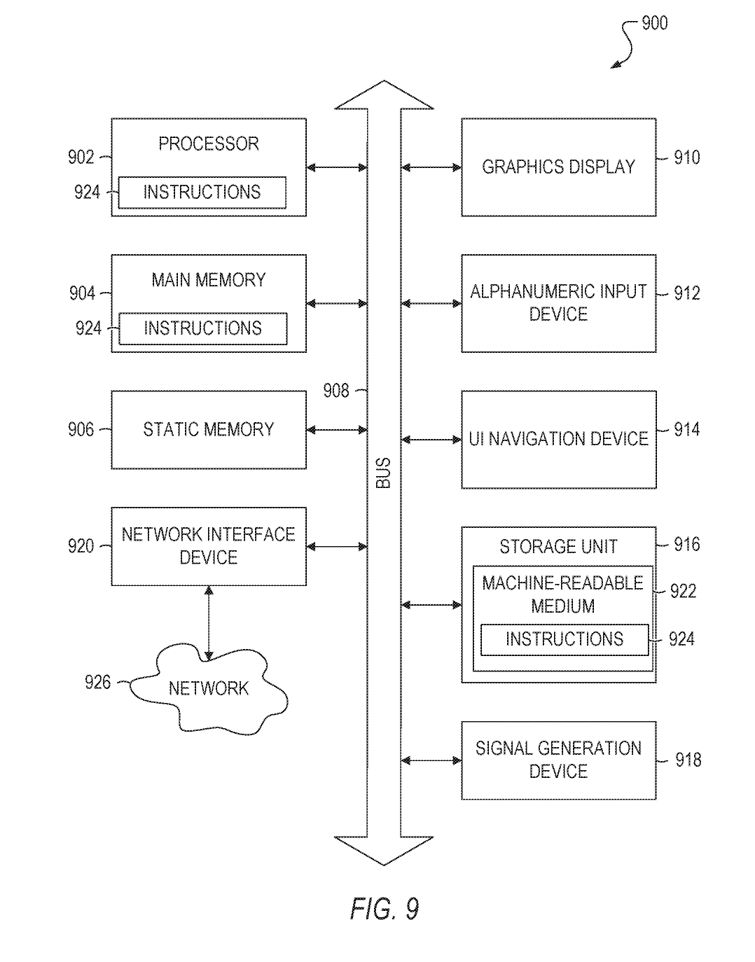

FIG. 9 is a block diagram of an example computer system 900 on which methodologies described herein may be executed, in accordance with an example embodiment. In alternative embodiments, the machine operates as a standalone device or may be connected (e.g., networked) to other machines. In a. networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a graphics display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a storage unit 916, a signal generation device 918 (e.g., a speaker) and a network interface device 920.

### Machine-Readable Medium

The storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions (e.g., instructions 924) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, by at least one hardware processor, a request from a first device of a first user of a social network service;
identifying, by the at least one hardware processor, digital content based on the request;
accessing, by the at least one hardware processor, user data of the first user, the user data of the first user comprising at least one of profile data of the first user and activity data of the first user;
determining, by the at least one hardware processor, that the accessed user data of the first user does not satisfy a quality model, the quality model requiring that at least two criteria of a plurality of criteria be satisfied by the accessed user data; and
performing, by the at least one hardware processor, a restriction operation based on the determining that the accessed user data of the first user does not satisfy the quality model, the restriction operation comprising one of preventing the digital content from being displayed to the first user, preventing the first user from submitting input associated with the digital content to the social networking service, and preventing input submitted by the first user in association with the digital content submitted from being displayed on a second device of a second user.

2. The computer-implemented method of claim 1, wherein the user data comprises the profile data, the profile data comprising a geographic location of the first user, and the plurality of criteria comprises the geographic location of the first user being within a predetermined geographical location.

3. The computer-implemented method of claim 1, wherein the user data comprises the activity data, the activity data comprising a number of times the first user has applied for a job within a predetermined period of time, and the plurality of criteria comprises the number of times the first user has applied for a job within the predetermined period of time being less than a threshold number.

4. The computer-implemented method of claim 1, wherein the user data comprises the profile data, the profile data comprising a salary data of the first user, and the plurality of criteria comprises the salary data of the first user being within a predetermined range.

5. The computer-implemented method of claim 1, wherein the digital content comprises a job posting.

6. The computer-implemented method of claim 5, wherein the restriction operation comprises preventing the job posting from being displayed to the first user.

7. The computer-implemented method of claim 5, wherein the restriction operation comprises preventing the first user from submitting input in association with the job posting to the social networking service, the job posting having been displayed to on the first device of the first user via the social networking service.

8. The computer-implemented method of claim 5, wherein the restriction operation comprises preventing input submitted by the first user in association with the job posting via the social networking service from being displayed on a second device of a second user.

9. The computer-implemented method of claim 1, further comprising:
accessing performance data of the social networking service; and
using a machine learning algorithm to modify the quality model based on the accessed performance data.

10. A system comprising:
at least one hardware processor; and
a non-transitory machine-readable medium embodying a set of instructions that, when executed by the at least one processor, cause the at least one processor to perform operations, the operations comprising:
receiving a request from a first device of a first user of a social network service;
identifying digital content based on the request;
accessing user data of the first user, the user data of the first user comprising at least one of profile data of the first user and activity data of the first user;
determining that the accessed user data of the first user does not satisfy a quality model, the quality model requiring that at least two criteria of a plurality of criteria be satisfied by accessed user data; and
performing a restriction operation based on the determining that the accessed user data of the first user does not satisfy the quality model, the restriction operation comprising one of preventing the digital content from being displayed to the first user, preventing the first user from submitting input associated with the digital content to the social networking service, and preventing input submitted by the first user in association with the digital content submitted from being displayed on a second device of a second user.

11. The system of claim 10, wherein the user data comprises the profile data, the profile data comprising a geographic location of the first user, and the plurality of criteria comprises the geographic location of the first user being within a predetermined geographical location.

12. The system of claim 10, wherein the user data comprises the activity data, the activity data comprising a number of times the first user has applied for a job within a predetermined period of time, and the plurality of criteria comprises the number of times the first user has applied for a job within predetermined period of time being less than a threshold number.

13. The system of claim 10, wherein the user data comprises the profile data, the profile data comprising a salary data of the first user, and the plurality of criteria comprises the salary data of the first user being within a predetermined range.

14. The system of claim 10, wherein the digital content comprises a job posting.

15. The system of claim 14, wherein the restriction operation comprises preventing the job posting from being displayed to the first user.

16. The system of claim 14, wherein the restriction operation comprises preventing the first user from submitting input in association with the job posting to the social networking service, the job posting having been displayed to on the first device of the first user via the social networking service.

17. The system of claim 14, wherein the restriction operation comprises preventing input submitted by the first user in association with the job posting via the social networking service from being displayed on a second device of a second user.

18. The system of claim 10, wherein the operations further comprise:
accessing performance data of the social networking service; and
using a machine learning algorithm to modify the quality model based on the accessed performance data.

19. A non-transitory machine-readable medium embodying a set of instructions that, when executed by a processor, cause the processor to perform operations, the operations comprising:
receiving a request from a first device of a first user of a social network service;
identifying digital content based on the request;
accessing user data of the first user, the user data of the first user comprising at least one of profile data of the first user and activity data of the first user;
determining that the accessed user data of the first user does not satisfy a quality model, the quality model requiring that at least two criteria of a plurality of criteria be satisfied by the accessed user data; and
performing a restriction operation based on the determining that the accessed user data of the first user does not satisfy the quality model, the restriction operation comprising one of preventing the digital content from being displayed to the first user, preventing the first user from submitting input associated with the digital content to the social networking service, and preventing input submitted by the first user in association with the digital content submitted from being displayed on a second device of a second user.

20. The non-transitory machine-readable medium of claim 19, wherein:
the digital content comprises a job posting;
the user data comprises the profile data and the activity data, the profile data comprising a geographic location of the first user and a salary data of the first user, and the activity data comprising a number of times the first user has applied for a job within a predetermined period of time; and
the plurality of criteria comprises the geographic location of the first user being within a predetermined geographical location, the salary data of the first user being within a predetermined range, and the number of times the first user has applied for a job within the predetermined period of time being less than a threshold number.
